(19) United States
(12) Patent Application Publication
(10) Pub. No.: US 2012/0278302 A1
(43) Pub. Date: Nov. 1, 2012

(54) MULTILINGUAL SEARCH FOR TRANSLITERATED CONTENT

(75) Inventors: Monojit Choudhury, Bangalore (IN); Kalika Bali, Bangalore (IN); Kanika Gupta, Delhi (IN); Narendranath Datha, Bangalore (IN)

(73) Assignee: MICROSOFT CORPORATION, Redmond, WA (US)

(21) Appl. No.: 13/098,359

(22) Filed: Apr. 29, 2011

(51) Int. Cl. G06F 17/30

(52) U.S. Cl. 707/709; 707/741; 707/723; 707/737; 707/E17.083; 707/E17.005; 707/E17.061; 707/E17.089

(57) ABSTRACT

The multilingual search for transliterated content technique described herein enables a user to submit a search query in both a native script and its foreign script (e.g., Roman script) transliteration and return relevant results in both the scripts while taking care of the spelling variations in transliterated forms. The technique crawls the World Wide Web for data in both the native script and foreign script transliterated forms of the data. It uses a transliteration engine to generate native script equivalents of the foreign script transliterated data and disambiguates the data in native script (whenever possible). The unique native script word forms are then used to jointly index the data in both the scripts. If the query is in native script, it is directly searched for in the index, otherwise the transliterated query is first converted into native script form(s) and then searched in the indexed database to retrieve and rank results in both the scripts.

### BACKGROUND

Transliteration is the practice of converting text from one system of writing to another in a systematic way. It involves changing words, letters or phrases in one system of writing to corresponding characters of another writing script or language. For languages which do not use the Roman Script (e.g., Hindi and other Indian languages, Arabic, Thai, Chinese, Japanese, Korean), the content on the World Wide Web is often found in Roman transliterations as well as in native scripts.

Searching the Web for such content becomes challenging because there is no single standard for transliteration. For instance, the Hindi word “ [symbol] ” can be transliterated into Roman script as hamein, hummey, hummein, hume, humen and so on, and therefore, the Hindi song title “hamein aur jeene ki . . . ”can be spelled in Web documents in a large number of ways. Further, the content is also present in the native script (in this case, Devanagari), which most of the users who are looking for its transliterated version would be able to read.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The multilingual search for transliterated content technique described herein enables a user to submit a search query in either a native script and its foreign script (e.g., Roman script) transliteration (the native script transliterated into a foreign script, such as, for example, Roman script) and returns relevant search results in both of the scripts while taking care of the spelling variations in transliterated forms. In one embodiment, the technique employs web crawlers to crawl the Web for data in both the native script and associated foreign script (e.g., Roman script) transliterated forms. It uses a transliteration engine to generate the native script equivalents of the foreign script (e.g., Roman script) transliterated data and to disambiguate using the data in native script (whenever possible). The unique native script equivalent word forms are then used to jointly index the data in both of the scripts. If the query is in native script, it is directly searched for in the index, otherwise the transliterated query is first converted into native script form(s) and then searched in the indexed database to retrieve and rank results in both the scripts.

The technique uses transliteration equivalents for handling spelling variations for searching transliterated data by joint indexing of data in native script and transliterated form and/or back-transliterating the query into the native script before searching through the index. The technique provides multilingual search for transliterated content on Web, where a query can be presented in either native script or its transliterated form and search results can be retrieved in both the scripts.

### DESCRIPTION OF THE DRAWINGS

The specific features, aspects, and advantages of the disclosure will become better understood with regard to the following description, appended claims, and accompanying drawings where:

FIG. 1 depicts a flow diagram of an exemplary process for employing one embodiment of the multilingual search for transliterated content technique described herein.

FIG. 2 depicts another flow diagram of an exemplary process for indexing native and transliterated content in one embodiment of the multilingual search for transliterated content technique described herein.

FIG. 3 is an exemplary architecture for practicing one exemplary embodiment of the multilingual search for transliterated content technique described herein.

FIG. 4 is a schematic of an exemplary computing environment which can be used to practice the multilingual search for transliterated content technique.

### DETAILED DESCRIPTION

In the following description of the multilingual search for transliterated content technique, reference is made to the accompanying drawings, which form a part thereof, and which show by way of illustration examples by which the multilingual search for transliterated content technique described herein may be practiced. It is to be understood that other embodiments may be utilized and structural changes may be made without departing from the scope of the claimed subject matter.

### 1.0 Multilingual Search for Transliterated Content Technique

The following sections provide an overview of the multilingual search for transliterated content technique, as well as exemplary processes and an exemplary architecture for practicing the technique.

### 1.1 Overview of the Technique

Although much transliterated data exists on the Web in the form of songs (e.g., lyrics and titles), blogs, poetry and other literary content, to name but a few, current search engines do not typically effectively address the issues of spelling variations and multilingualism for such content. This is true for both the query and the searched content sides of the search equation. The multilingual search for transliterated content technique described herein can retrieve results for a query in the native script or its foreign script (e.g., Roman script) transliterated form using a transliteration engine for cross lingual indexing and search.

Current search engines in the market today employ keyword matching techniques, along with minor spelling corrections, when trying to match a search query with document content. Therefore, a spelling variation in a given query may lead to no search results or unrelated search results. As a result, searching through Roman transliterated documents becomes a difficult task as the transliteration spelling conventions vary from user to user, and region to region.

While some commercial search engines support queries in scripts other than Roman, the documents retrieved by such search engines are always in the script of the query. The term “cross-lingual retrieval” is usually understood to mean searching for a concept across two or more languages where the results are ideally presented in the language of the query. However, transliterated data, though present in two different scripts, represents a single language which cannot benefit from the standard understanding and models for cross-lingual search.

The multilingual search for transliterated content technique described herein is a technology that allows the user to query in both a native script and its transliteration in a foreign script (for example, Roman transliteration) and return relevant results in both the scripts while taking care of the spelling variations in transliterated forms. More often than not, a user in this case is familiar with both the scripts and is using the Roman transliteration because of unavailability of popular input methods and relevant data in the native script. Therefore, this technique increases the accessibility of the Web for a user of a language using native script without any additional effort in terms of learning to use special software/hardware for typing in the native script. Furthermore, the technique improves the monolingual retrieval performance by handling spelling variations that are more common and unique to the transliterated content.

### 1.2 Exemplary Processes for Practicing the Technique

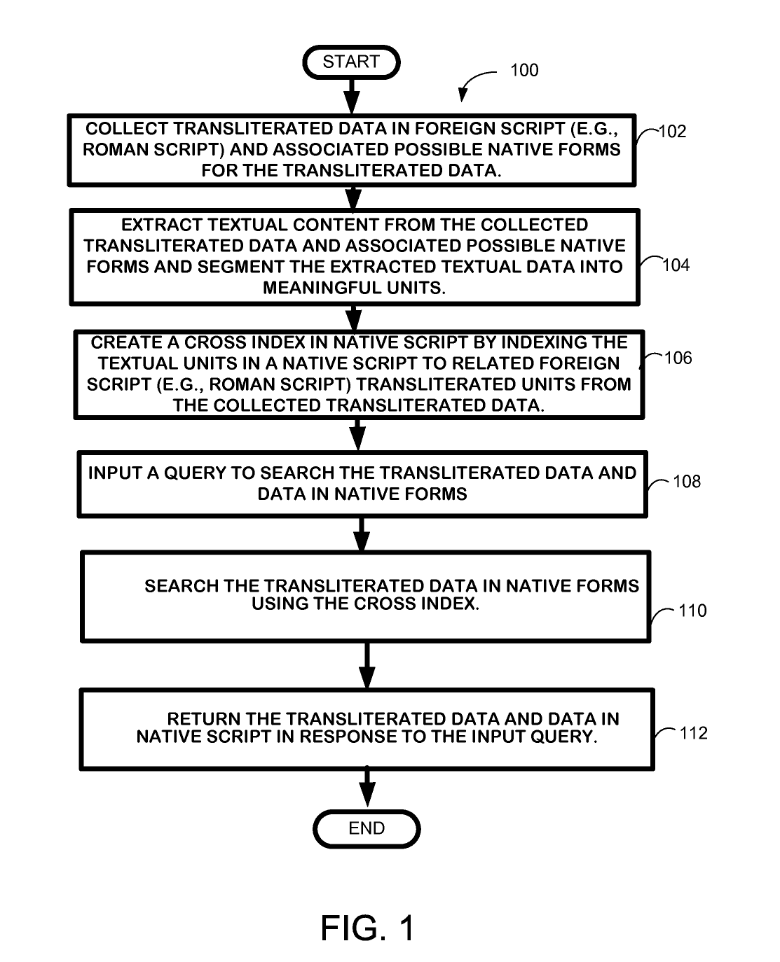

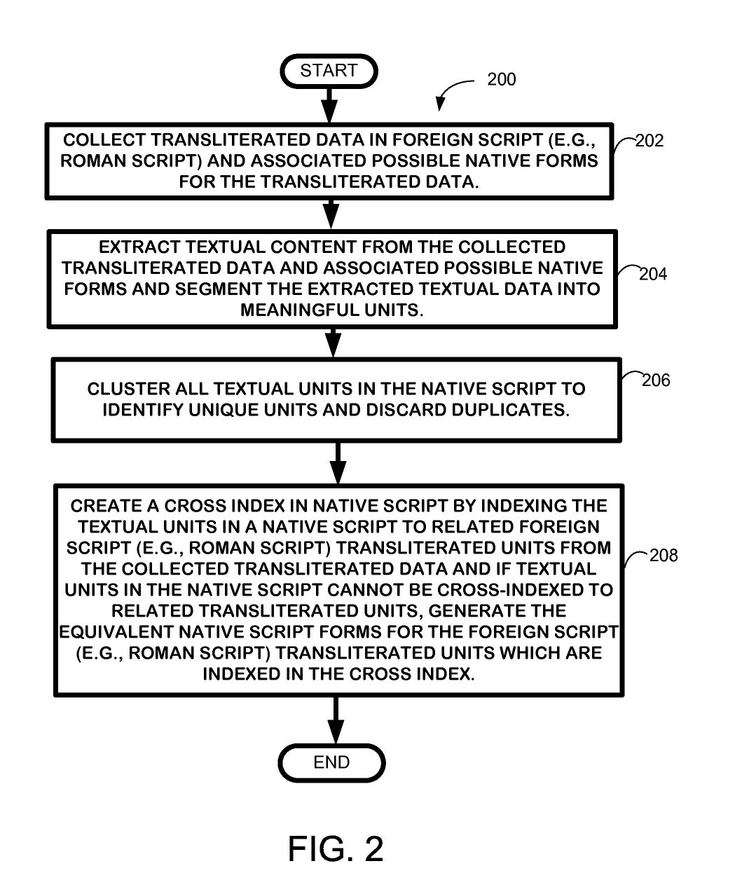

FIG. 1 provides an exemplary process for practicing one embodiment of the multilingual search for transliterated content technique. As shown if FIG. 1, block 102, foreign script (for example, Roman script) transliterated data and its possible native forms are collected from different websites by using web crawlers. In one embodiment, the technique does this by identifying specific websites which possibly contain transliterated data (e.g., song lyrics websites, movie databases, poetry blogs and discussion forums), and also a host of other websites that might contain the same data in the native scripts. The technique extracts textual content from these websites, and segments them into meaningful units (titles, paragraphs, stanzas etc.), as shown in block 104. Indexing of this data then takes place, as shown in block 106. In one embodiment of the technique, to perform indexing, the technique uses textual units in the native script to cross-index related foreign script (e.g., Roman script) transliterated units, wherever such indexing is possible. Details of the indexing used in one embodiment of the technique are described with respect to FIG. 2. If textual units in the native script are not available for units of the transliterated data, the technique uses a transliteration engine to generate the equivalent native script forms for the foreign script (e.g., Roman script) transliterated unit to allow cross-indexing.

In one embodiment of the technique, as shown in FIG. 2, the indexing proceeds in two steps, by monolingual clustering of textual units, and then by cross indexing. Once the transliterated data in foreign script (e.g., Roman script) and the associated possible native forms for the transliterated data have been collected and segmented (blocks 202, 204), the technique clusters all the textual units in the native script to identify the unique units, as shown in block 206 and duplicates are discarded. These clustered unique textual units in the native script serve as the index. The technique then performs cross indexing, as shown in block 208. For each unit in foreign script (e.g., Roman script) transliteration, the technique identifies the unique native script cluster that it might represent. This is done by comparing the transliterated forms of the foreign script (e.g., Roman script) transliterated unit generated by the transliteration engine with the existing native script units. If no suitable match is found, the transliterated form generated by the engine is added as a new native script unit in the index and cross-linked to the source foreign script (e.g., Roman script) unit. Standard information retrieval (IR) techniques are followed to build a word level index for each unique unit thus produced for the native script. In one embodiment the index has the following components for each native script entry: unique word in native script that is used as the key for the entry, all the unique native and foreign script (e.g., Roman script) transliterated textual unit pairs that contain the word or its foreign script (e.g., Roman script) transliteration, and for each unit, the list of documents (i.e., webpage URLs) that contain the unit.

Referring back to FIG. 1, block 108, once the cross index is created, a user query is input (e.g., through a multilingual search tool for transliterated content). It can be a query in a native script or a query in a Roman transliterated form, which can be processed differently. These two cases are described in greater detail below.

Given a query in native script, in one embodiment of the technique, the query terms are searched for in the native script word level index (block 220) and the units are ranked using standard IR techniques. For example, in one embodiment, for every word in the query, from the index the technique obtains a list of associated units. A match score is computed for every unique unit considering (a) how many words in the query are present in the unit in native script, and (b) to what extent the order of occurrence of the words in the query is preserved in the unit. The higher the above values, the higher is the match score. Every unique document associated with the matching units is then ranked by considering (a) the match score of the unit(s) associated with the document, and (b) the type of the unit associated with the document, which matches the query (e.g., match in a title unit is considered better match than match in a paragraph from the middle of the document). The results are returned and optionally displayed (block 112).

If the query is in a foreign script (e.g., Roman script) transliterated form, the technique applies the transliteration engine to generate all the relevant native script forms for the query. These native script queries are then searched for in the index using the technique mentioned above with respect to the query being in native script (block 110). The results are returned/displayed (block 112) after using the unit level matches to identify document level matches to present a ranked list of documents (e.g., URLs to documents), as indicated by the cross index. It should be noted that in one embodiment of the technique, the URLs are clustered. Each cluster can contain, for example, URLs that are related to the same song or the same movie. Thus, in this embodiment, foreign script and native script URLs can be listed together within a cluster.

Thus, the results retrieved can be retrieved in both the native and foreign scripts whenever available. The user can opt to see the results in only one of the scripts, in which case though the results are available only those in the relevant script are displayed.

### 1.6 Exemplary Architecture

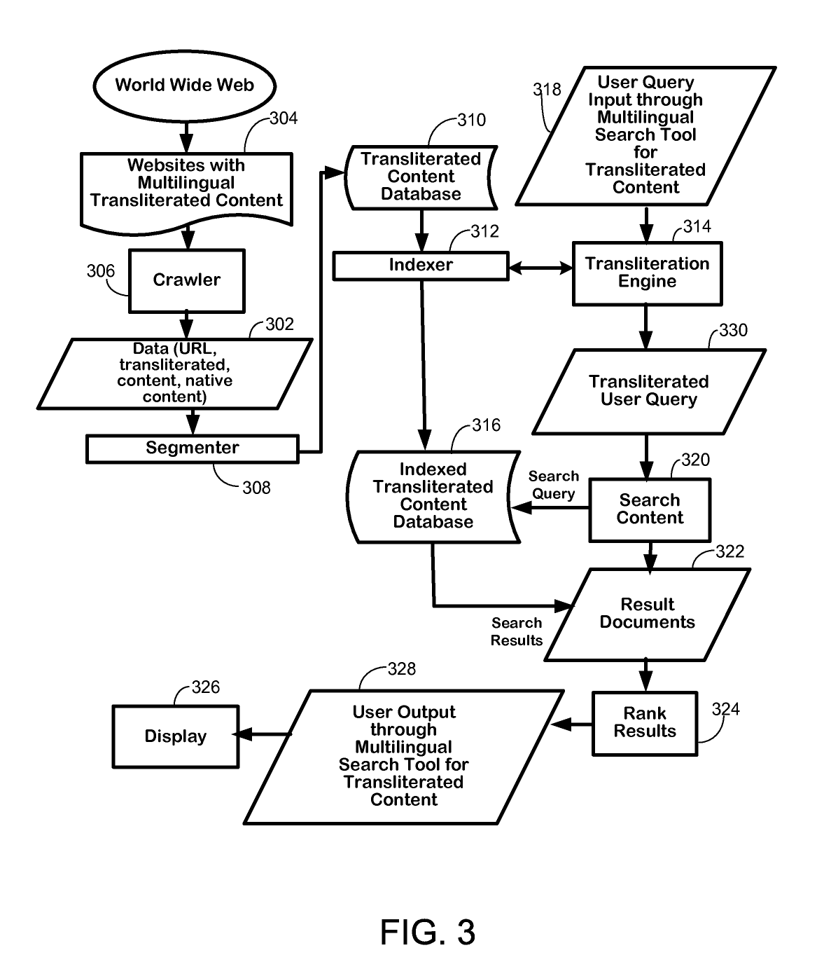

FIG. 3 shows an exemplary architecture 300 for practicing one embodiment of the multilingual search for transliterated content technique. As shown if FIG. 3, foreign script (e.g., Roman script) transliterated data and their possible native forms 302 are collected from different websites 304 by one or more web crawlers 306. In one embodiment the technique identifies specific websites which possibly contain transliterated data (e.g., song lyrics websites, movie databases, poetry blogs and discussion forums), and also a host of other websites that might contain the same data in the native scripts. The web crawlers 306 extract textual content 302 from these websites, and the textual content 302 is segmented into meaningful units (titles, paragraphs, stanzas, and so forth) using a segmenter 308 and conventional segmentation techniques. This results in a transliterated content database 310. Indexing of this data then takes place in an indexer 312. In one embodiment of the technique, to perform indexing in the indexing module 312, the technique uses textual units in the native script to cross-index related foreign script (e.g., Roman script) transliterated units, wherever such indexing is possible. Otherwise the technique uses a transliteration engine (block 314) to generate the equivalent native script forms for the foreign script (e.g., Roman script) transliterated unit to allow cross-indexing.

The indexer 312 indexes the data as follows. In one embodiment, the indexer 312 first clusters all the textual units in the native script to identify the unique units. These clustered textual unique units in the native script serve as the index. For each unit in foreign script (e.g,. Roman script) transliteration, the technique identifies the unique native script cluster that it might represent. This is done by comparing the transliterated forms of the foreign script unit generated by the transliteration engine with the existing native script units. If no suitable match is found, the transliterated form generated by the engine is added as a new native script unit in the index and cross-linked to the source foreign script unit. Standard information retrieval (IR) techniques are followed to build a word level index for each unique unit thus produced for the native script. This results in an indexed transliterated content database 316.

Referring back to FIG. 3, a user query is input through a multilingual search tool 318 for transliterated content. The query 312 can be a query in a native script or a query in a Roman transliterated form, which can be processed differently. If the query is in native script, the query terms are searched for (e.g., using a search engine 320 in the native script word level index 316 and the units are ranked in a ranker 324 using standard IR techniques. For example, in one working embodiment of the technique, for a native script query, the technique directly searches each word of the query in the the indexed transliterated content database 316 and then ranks the retrieved search results 322 using the procedure previously described with respect to FIG. 2. The retrieved search results 322 are displayed on a display 326 via a multi-lingual search tool 328.

If the query is in Roman transliterated form, the technique applies the transliteration engine 314 to generate relevant native script forms for the query in the form of a reverse transliterated query 330. For example, a transliteration engine usually generates a number of possible native script variants of the input foreign script (e.g., Roman script) transliterations. In this case the technique can take a predefined number of options generated by the transliteration engine for each word and generate native language queries by combining these options in all possible ways, For instance, if the transliterated query is “x y”, and the transliteration engine generated x1, x2, x3, x4, . . . as possible ranked native forms for x, and similarly, y1, y2, y3, y4, . . . for y, and if the predefined value is 2, then considering only the top two possible forms for the words (x1 and x2 for x and y1 and y2 for y), the technique can generate the following 4 possible queries: x1 y1, x2 y1, x1 y2, x2 y2. And then the technique can search for these queries as previously described. These native script queries are then searched for (block 320) in the index 316 using the technique mentioned above with respect to the query being in native script. The search results 322 are again displayed.

Thus, the results can be retrieved in both the scripts whenever available. The user can opt to see the results in only one of the scripts, in which case though the results are available only those in the relevant script are displayed.

It should be noted that the segmenter 308, transliterated content database 310, indexer 312, indexed transliterated content data base 316, as well as the transliteration engine 314, or combinations of one or more of these components, can reside on a user's personal computing device, a server or even a computing cloud.

### 2.0 Exemplary Operating Environments:

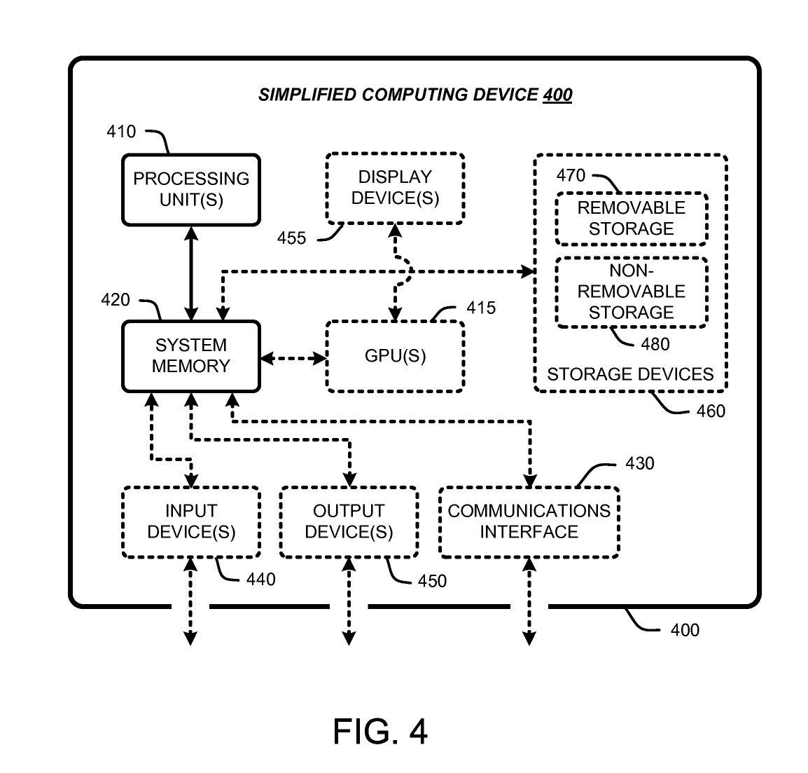

The multilingual search for transliterated content technique described herein is operational within numerous types of general purpose or special purpose computing system environments or configurations. FIG. 4 illustrates a simplified example of a general-purpose computer system on which various embodiments and elements of the multilingual search for transliterated content technique, as described herein, may be implemented. It should be noted that any boxes that are represented by broken or dashed lines in FIG. 4 represent alternate embodiments of the simplified computing device, and that any or all of these alternate embodiments, as described below, may be used in combination with other alternate embodiments that are described throughout this document.

For example, FIG. 4 shows a general system diagram showing a simplified computing device 400. Such computing devices can be typically found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, audio or video media players, etc.

To allow a device to implement the multilingual search for transliterated content technique, the device should have a sufficient computational capability and system memory to enable basic computational operations. In particular, as illustrated by FIG. 4, the computational capability is generally illustrated by one or more processing unit(s) 410, and may also include one or more GPUs 415, either or both in communication with system memory 420. Note that that the processing unit(s) 410 of the general computing device of may be specialized microprocessors, such as a DSP, a VLIW, or other micro-controller, or can be conventional CPUs having one or more processing cores, including specialized GPU-based cores in a multi-core CPU.

In addition, the simplified computing device of FIG. 4 may also include other components, such as, for example, a communications interface 430. The simplified computing device of FIG. 4 may also include one or more conventional computer input devices 440 (e.g., pointing devices, keyboards, audio input devices, video input devices, haptic input devices, devices for receiving wired or wireless data transmissions, etc.). The simplified computing device of FIG. 4 may also include other optional components, such as, for example, one or more conventional computer output devices 450 (e.g., display device(s) 455, audio output devices, video output devices, devices for transmitting wired or wireless data transmissions, etc.). Note that typical communications interfaces 430, input devices 440, output devices 450, and storage devices 460 for general-purpose computers are well known to those skilled in the art, and will not be described in detail herein.

The simplified computing device of FIG. 4 may also include a variety of computer readable media. Computer readable media can be any available media that can be accessed by computer 400 via storage devices 460 and includes both volatile and nonvolatile media that is either removable 470 and/or non-removable 480, for storage of information such as computer-readable or computer-executable instructions, data structures, program modules, or other data. By way of example, and not limitation, computer readable media may comprise computer storage media and communication media. Computer storage media includes, but is not limited to, computer or machine readable media or storage devices such as DVD's, CD's, floppy disks, tape drives, hard drives, optical drives, solid state memory devices, RAM, ROM, EEPROM, flash memory or other memory technology, magnetic cassettes, magnetic tapes, magnetic disk storage, or other magnetic storage devices, or any other device which can be used to store the desired information and which can be accessed by one or more computing devices.

Storage of information such as computer-readable or computer-executable instructions, data structures, program modules, etc., can also be accomplished by using any of a variety of the aforementioned communication media to encode one or more modulated data signals or carrier waves, or other transport mechanisms or communications protocols, and includes any wired or wireless information delivery mechanism. Note that the terms “modulated data signal” or “carrier wave” generally refer a signal that has one or more of its characteristics set or changed in such a manner as to encode information in the signal. For example, communication media includes wired media such as a wired network or direct-wired connection carrying one or more modulated data signals, and wireless media such as acoustic, RF, infrared, laser, and other wireless media for transmitting and/or receiving one or more modulated data signals or carrier waves. Combinations of the any of the above should also be included within the scope of communication media.

Further, software, programs, and/or computer program products embodying the some or all of the various embodiments of the multilingual search for transliterated content technique described herein, or portions thereof, may be stored, received, transmitted, or read from any desired combination of computer or machine readable media or storage devices and communication media in the form of computer executable instructions or other data structures.

Finally, the multilingual search for transliterated content technique described herein may be further described in the general context of computer-executable instructions, such as program modules, being executed by a computing device. Generally, program modules include routines, programs, objects, components, data structures, etc., that perform particular tasks or implement particular abstract data types. The embodiments described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

It should also be noted that any or all of the aforementioned alternate embodiments described herein may be used in any combination desired to form additional hybrid embodiments. Although the subject matter has been described in language specific to structural features and/or methodological acts, it is to be understood that the subject matter defined in the appended claims is not necessarily limited to the specific features or acts described above. The specific features and acts described above are disclosed as example forms of implementing the claims.

What is claimed is:

1. A computer-implemented process for searching for transliterated content, comprising:
collecting transliterated data in a foreign script and associated possible native forms for the transliterated data;
extracting textual content from the collected transliterated data and associated possible native forms and segmenting the extracted textual data into meaningful units;
creating a cross index in native script by indexing the textual units in a native script to related foreign script transliterated units from the collected transliterated data;
inputting a query to search the transliterated data and data in native forms;
searching the transliterated data and data in native forms using the cross index; and
returning transliterated data and data in native script in response to the input query.

2. The computer-implemented process of claim 1, further comprising if a textual unit in the native script cannot be cross-indexed to one or more related foreign script transliterated units, generating equivalent native script forms for the foreign script transliterated unit which are indexed in the cross index.

3. The computer-implemented process of claim 1 wherein the query is input in native script.

4. The computer-implemented process of claim 3, further comprising:
searching for terms of the query in native script in the native script cross index;
retrieving results the match the query in both the native script and in a transliterated foreign script;
ranking the retrieved results to the query; and
displaying the ranked results in native script along with the corresponding results in foreign script as indicated by the cross index.

5. The computer-implemented process of claim 1 wherein the query is in transliterated foreign script.

6. The computer-implemented process of claim 5, further comprising:
applying the transliteration engine to the query in transliterated foreign script to generate all relevant native script forms for the query in transliterated foreign script;
using the transliterated queries in native script to search for terms of the queries in the native script cross index;
retrieving results that match the query in both the native script and in a transliterated foreign script;
ranking the retrieved results to the transliterated query; and
displaying the ranked results in native script along with the corresponding results in foreign script as indicated by the cross index.

7. The computer-implemented process of claim 1, further comprising a user choosing to view the transliterated returned data, the returned data in native script or both the transliterated returned data and the returned data in native script.

8. The computer-implemented process of claim 1 wherein creating a cross index further comprises:
clustering all of the textual units in the native script to identify the unique units;
discarding non-unique units;
using the clustered textual unique units in the native script as the index;
for each unit in foreign script transliteration, identifying the unique native script cluster that it might represent;
if no suitable match is found, generating a new native script unit using a transliteration engine and adding the new native script unit in the index, cross-linked to the source foreign script unit.

9. The computer-implemented process of claim 8, for each unit in foreign script transliteration, identifying the unique native script cluster that it might represent is performed by comparing the transliterated forms of the foreign script transliterated unit generated by the transliteration engine with the existing native script units.

10. The computer-implemented process of claim 1, wherein the transliterated data is collected from websites by using one or more web crawlers.

11. The computer-implemented process of claim 1, wherein foreign script is Roman script.

12. A computer-implemented process for creating a database indexed to be used for searching for transliterated content, comprising:
collecting transliterated data and associated possible native forms of the transliterated data;
extracting textual content from the collected transliterated data and segmenting the extracted textual content into meaningful units;
creating a cross index by indexing the textual units in a native script to related foreign script transliterated units and if textual units in the native script cannot be cross-indexed to related transliterated units, generating equivalent native script forms for the foreign script transliterated unit which are indexed in the cross index.

13. The computer-implemented process of claim 12, further comprising:
inputting a query to search the transliterated data and data in native forms;
returning transliterated data and data in native script in response to the input query.

14. The computer-implemented process of claim 13 wherein the query is in transliterated foreign script, and wherein the query is used to search the cross index further comprising:
applying the transliteration engine to the query in transliterated foreign script to generate all the relevant native script forms for the query in transliterated foreign script;
using the transliterated queries in native script to search for terms of the queries in the native script cross index;
retrieving results that match the query in both the native script and transliterated forms in a foreign script;
ranking the retrieved results to the transliterated queries; and
displaying the ranked results in native script along with the corresponding results in foreign script as indicated by the cross index.

15. The computer-implemented process of claim 14 wherein the query is in native script, further comprising:
searching for terms of the query in native script in the native script cross index;
retrieving results that match the query in both the native script and transliterated forms in a foreign script;
ranking the results retrieved for the query; and
displaying the ranked results in native script along with the corresponding results in foreign script as indicated by the cross index.

16. A system for searching for transliterated content, comprising:
a general purpose computing device;
a computer program comprising program modules executable by the general purpose computing device, wherein the computing device is directed by the program modules of the computer program to,
collect multi-lingual transliterated data and associated native script forms for the transliterated data;
create a cross index in native script by indexing textual data units of the collected multi-lingual transliterated data in a native script to related foreign script transliterated units from the collected multi-lingual transliterated data;
input a query to search the collected transliterated data and associated data in native forms;
search the multi-lingual transliterated data and data in native forms using the cross index; and
return transliterated data and data in native script in response to the input query.

17. The system of claim 16 wherein the cross index comprises:
unique words in native script;
all the unique native and foreign script transliterated textual unit pairs that contain a given word or its foreign script transliteration;
and for each textual unit, the list of webpage URLs that contain the textual unit.

18. The system of claim 16, further comprising a multi-lingual search tool for searching the collected multi-lingual transliterated data and native script forms for the multi-lingual transliterated data.

19. The system of claim 16 wherein the system resides on a server.

20. The system of claim 16 wherein the system resides on a computing cloud.
